(19) United States
(12) Patent Application Publication
(10) Pub. No.: US 2006/0027680 A1
(43) Pub. Date: Feb. 9, 2006

(54) Mobile DC water sprayer

(76) Inventor: Scott Wu, Taichung Hsien (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/913,646

(22) Filed: Aug. 6, 2004

(51) Int. Cl. A62C 13/62

(52) U.S. Cl. 239/302

(57) ABSTRACT

A mobile DC water sprayer includes a housing, which has a water chamber for keeping water and a receiving chamber separated from the water chamber, a booster pump mounted in the receiving chamber inside the housing for pumping water out of the water chamber to the outside of the housing, and a power control unit, which has a first end electrically connected to the booster pump and a second end for connection to a DC power supplier to obtain DC power for the operation of the booster pump.

### BACKGROUND OF THE INVENTION

1. Field of the Invention

The present invention relates to a water sprayer and more particularly, to a mobile DC water sprayer, which uses DC power to start a booster pump to pump water out of the housing thereof.

2. Description of the Related Art

Various water spraying apparatus have been disclosed for use as means to wash bicycles, cars, etc., and have appeared on the market. A conventional water sprayer apparatus is designed to be “usable” only. A usable design of water spraying apparatus cannot attract consumers to buy. Taiwan Patent Publication Serial No. 463749 discloses a portable car washing gun. According to this design, the car washing gun comprises a housing, a power drive, a water delivery pipe, a sleeve, and a brush. The housing has a carrying handle for carrying. The power drive is mounted inside the housing. The water delivery pipe extends through the housing for delivering water from an external water source and has a front end terminating in a water spray pipe section. The sleeve is sleeved onto the water spray pipe section of the water delivery pipe. The brush is mounted around the sleeve and rotatable with the sleeve relative to the water spray pipe section of the water delivery pipe. This design of car washing gun is functional. However, it must be used with an external water source. When going outdoors, the user may be unable to find a water source. In this case, the car washing gun becomes not usable.

### SUMMARY OF THE INVENTION

The present invention has been accomplished under the circumstances in view. It is one object of the present invention to provide a mobile DC water sprayer, which has a water chamber in the housing thereof for keeping water so that the user needs not to search for a water source when going outdoors. It is another object of the present invention to provide a mobile DC water sprayer, which uses DC power to start a booster pump to pump water out of the housing thereof. To achieve these and other objects of the present invention, the mobile DC water sprayer comprises a housing, the housing comprising a water chamber for keeping water and a receiving chamber separated from the water chamber; a booster pump mounted in the receiving chamber inside the housing and adapted to pump water out of the water chamber to the outside of the housing; and a power control unit installed in the housing, the power control unit having a first end electrically connected to the booster pump and a second end for connection to a DC power supplier to obtain DC power for the operation of the booster pump.

### BRIEF DESCRIPTION OF THE DRAWINGS

FIG. 1 is an elevational view of a mobile DC water sprayer according to the present invention.

FIG. 2 is an exploded view of the mobile DC water sprayer according to the present invention.

FIG. 3 is a schematic side sectional view of the present invention, showing the mobile DC water sprayer in operation.

FIG. 4 is a schematic drawing showing an application example of the present invention.

### DETAILED DESCRIPTION OF THE PREFERRED EMBODIMENT

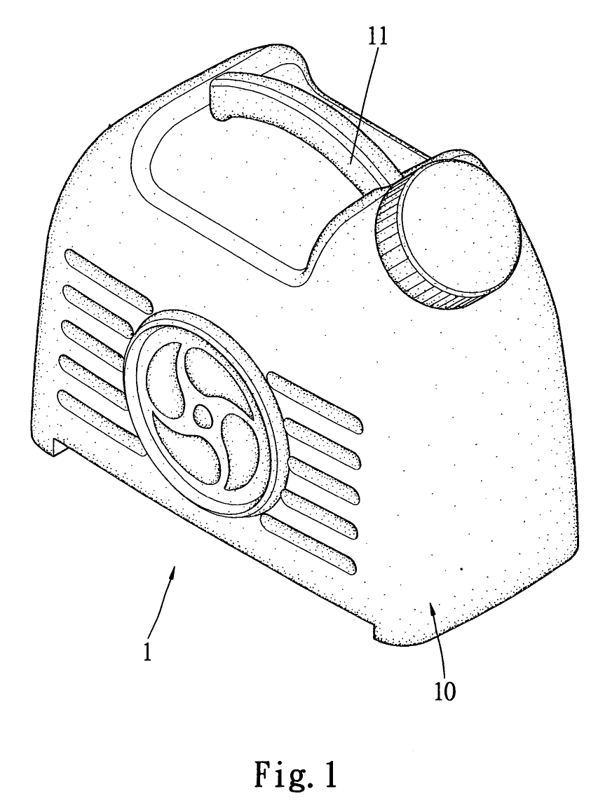

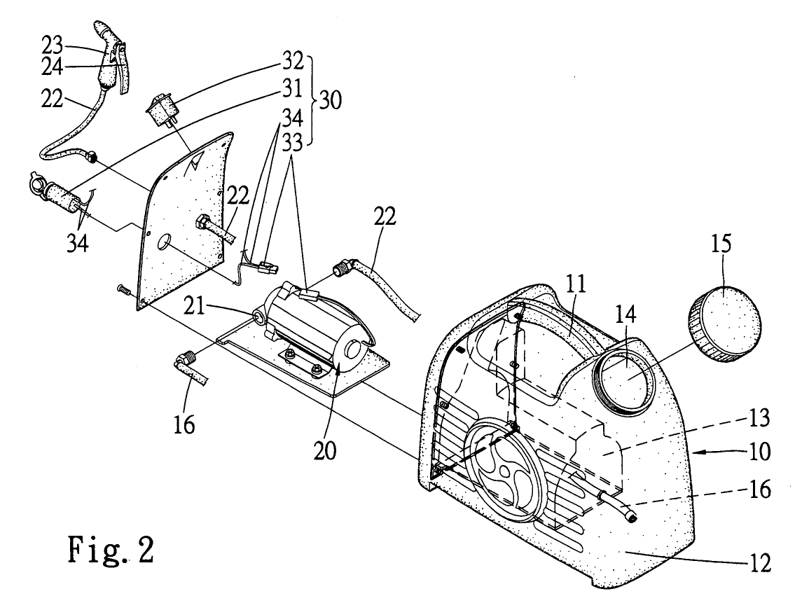

Referring to FIG. 1, a mobile DC water sprayer 1 in accordance with the present invention is shown having a housing 10 provided with a carrying handle 11 The housing 10 is adapted to hold water, and has a booster pump 20 installed therein (see also FIG. 2). The booster pump 20 consumes DC but not AC.

Referring to FIG. 2, the mobile DC water sprayer 1 comprises a housing 1, a booster pump 20, a water outlet tube 22, and a power control unit 30. The housing 1 has a carrying handle 11 formed integral with the outside wall thereof for carrying by the user's hand, a water chamber 12, a receiving chamber 13 separated from the water chamber 12, a filling hole 14 formed in the outside wall in fluid communication with the water chamber 12 and covered with a cap 15, and a water tube 16 extended from the water chamber 12 to the inside of the receiving chamber 13 for guiding water out of the water chamber 12 into the receiving chamber 13. The booster pump 20 is mounted inside the receiving chamber 13, having a first end and a second end. The first end of the booster pump 20 has a water input port 21 disposed at one side and connected to the water tube 16 to receive water from the water chamber 12 and a water output port (not shown) disposed at an opposite side for output of compressed water. The water outlet tube 22 has one end connected to the water output port of the booster pump 20, and the other end extended out of the housing 10 and mounted with a pistol nozzle 23, which is provided with a control lever 24 for operation control. The power control unit 30 comprises an electric connector 31, a power switch 32, and an electric adapter 33. The electric connector 31 and the power switch 32 are mounted in the outside wall of the housing 10. The electric adapter 33 has one end connected to the second end of the booster pump 20 and the other end electrically connected to the connector 31 and the power switch 32 by a respective electric wire 34. The electric connector 31 is electrically connected to the switch 32 by an electric wire 34.

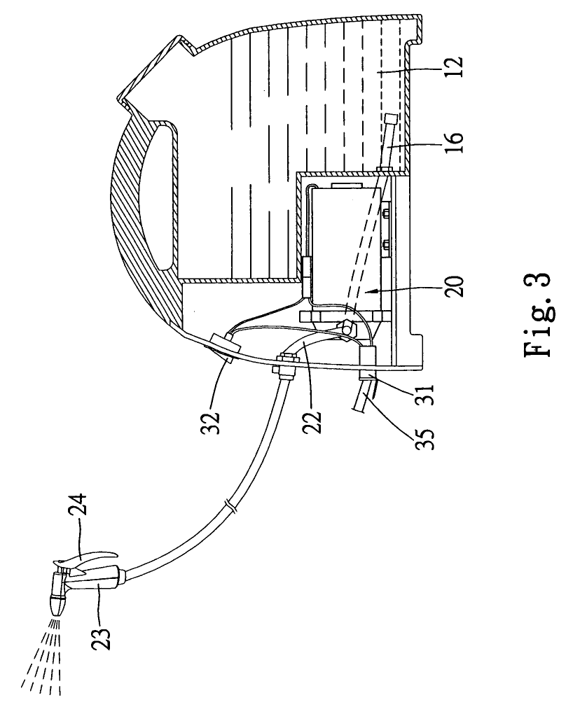

Referring to FIG. 3, an electric cable 35 is used to connect the electric connector 31 to an external DC power source (not shown). When switched on the power switch 32, the booster pump 20 is started to pump water from the water tube water tube 16 into the water outlet tube 22. When the user pressed the control lever 24 at this time, fine drops of water are forced out of the pistol nozzle 23.

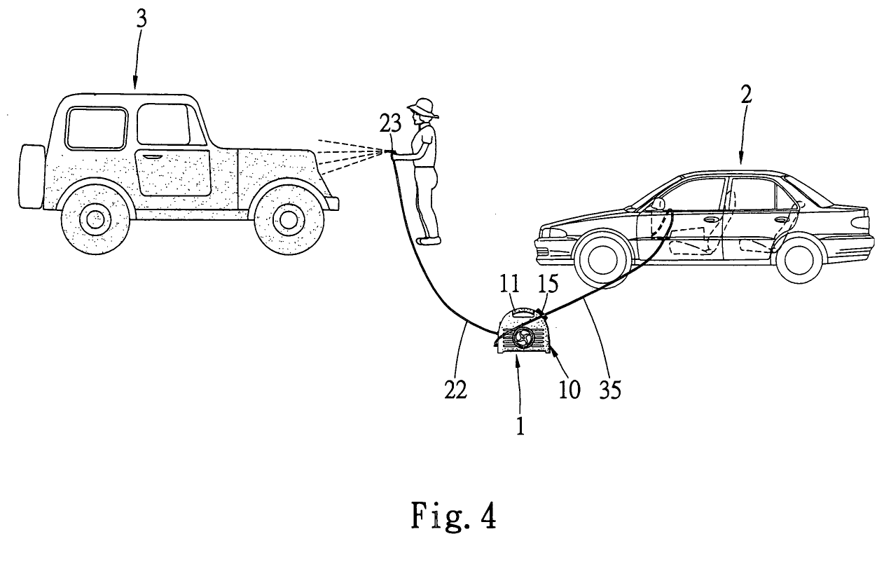

FIG. 4 shows an application example of the present invention to wash a car. As illustrated, the electric cable 35 connects the electric connector 31 to the socket for cigarette lighter of a first car 2 to obtain DC power supply from the first car 2 for the booster pump 20, and the user operates the pistol nozzle 23 to spray water over a second car 3.

A prototype of mobile DC water sprayer has been constructed with the features of FIGS. 1˜4. The mobile DC water sprayer functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A mobile DC water sprayer comprising
a housing, said housing comprising a water chamber for keeping water and a receiving chamber separated from said water chamber;
a booster pump mounted in said receiving chamber inside said housing and adapted to pump water out of said water chamber to the outside of said housing; and
a power control unit installed in said housing, said power control unit having a first end electrically connected to said booster pump and a second end for connection to a DC power supplier to obtain DC power for the operation of said booster pump.

2. The mobile DC water sprayer as claimed in claim 1, further comprising a handle formed integral with an outside wall of said housing for carrying by hand.

3. The mobile DC water sprayer as claimed in claim 1, wherein said housing comprises a filling hole in the periphery thereof in fluid communication with said water chamber.

4. The mobile DC water sprayer as claimed in claim 3, further comprising a cap adapted to close said filling hole.

5. The mobile DC water sprayer as claimed in claim 1, further comprising a water tube mounted inside said housing between said water chamber and said receiving chamber and adapted to guide water from said water chamber to said booster pump.

6. The mobile DC water sprayer as claimed in claim 1, wherein said booster pump has a water output port connected with a water outlet tube, said water outlet tube having an outer end extended out of said housing and mounted with a pistol nozzle for output of compressed water from said booster pump.

7. The mobile DC water sprayer as claimed in claim 6, wherein said pistol nozzle comprises a control lever for operation control.

8. The mobile DC water sprayer as claimed in claim 1, wherein said power control unit comprises an electric connector at the second end thereof for connection to a DC power supplier, an electric adapter electrically connected between said electric connector and said booster pump, and a power switch electrically connected between said electric connector and said electric adapter.

9. The mobile DC water sprayer as claimed in claim 8, said electric connector and said power switch are mounted in the periphery of said housing.

10. The mobile DC water sprayer as claimed in claim 8, further comprising a power cable adapted to connect said electric connector to a DC power supply means.

11. The mobile DC water sprayer as claimed in claim 10, wherein said DC power supply means is the electric socket for cigarette lighter of a motor vehicle.
